(19) United States
(12) Patent Application Publication
(10) Pub. No.: US 2005/0171850 A1
(43) Pub. Date: Aug. 4, 2005

(54) Device for ordering at dining table

(76) Inventor: Wen Hsiang Yueh, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/768,048

(22) Filed: Feb. 2, 2004

(51) Int. Cl. G06F 17/60

(52) U.S. Cl. 705/15; 705/26

(57) ABSTRACT

A device for ordering at a dining table, which is applied in a restaurant or an eatery, can be used to transmit menu messages, browse a menu status, pay the bill and surf the Internet. The device has a program control module used for performing a menu process, a transaction process and a digital transmission program. A first displayer is connected with the program control module to show a menu, a transaction status or a digital message. A first interface is connected with the program control module for connecting at least an external device. A first radio module is connected with the program control module for connecting the program control module with the remote host for data transferring.

### FIELD OF THE INVENTION

The present invention is directed to a device for ordering at a dining table, and more particularly, to an ordering device applied in a restaurant that can be used to transmit menu messages, browse menu statuses, pay the bill and surf the Internet.

### BACKGROUND OF THE INVENTION

In a restaurant or an eatery, a customer generally makes an order via a waiter or a waitress. Then, the ordering is taken to the counter or kitchen artificially as reference for cooking or charging. Hence, the waiter/waitress of the restaurant usually needs to shuttle between the dining tables, counter and kitchen. It increases the burden on the servers and degrades the quality of service.

Therefore, in some eateries, the counter has a host computer connecting with the dinning tables and kitchen for processing the menu messages sent from the ordering devices of the dinning tables and sending the menu messages to the kitchen for cooking.

However, the decoration of the restaurant or eatery often needs to be changed or replaced. Hence, the transmission lines in the store also need to be changed. This is highly inconvenient and expensive for the restaurant. Accordingly, the present invention aims to resolve this drawback in the prior art.

### SUMMARY OF THE INVENTION

An objective of the present invention is to provide a device for ordering at a dining table, which can provide a function of wireless transmission to send a menu message to remote hosts located at the counter and in the kitchen, respectively. At the same time, the device can be used to browse the menu status sent from the remote host of the kitchen, connect to the Internet via the remote host at the counter and call the server for a related service.

The ordering device of the present invention is able to access the Internet via the remote host at the counter and a memory card recording the authority limit of network using. Further, the ordering device has an interface for connecting with an external device and transferring data so as to know the menu status, pay by a credit card, etc.

For reaching the above objective, the ordering device of the present invention employs a program control module to perform a menu process, a transaction process and a digital transmission program and employs a first radio module to respectively communicate with the remote hosts located at the counter and in the kitchen and the portable device in a wireless manner.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of an ordering system in accordance with the present invention;

FIG. 2 is a circuit block of an ordering device in accordance with the present invention;

FIG. 3 is a circuit block diagram of a remote host in accordance with the present invention;

FIG. 4 is a schematic diagram of the ordering device in accordance with the present invention;

FIG. 5 is a schematic diagram of a remote host disposed at a counter in accordance with the present invention; and

FIG. 6 is a schematic diagram of a remote host disposed in the kitchen in accordance with the present invention.

### DETAILED DESCRIPTION

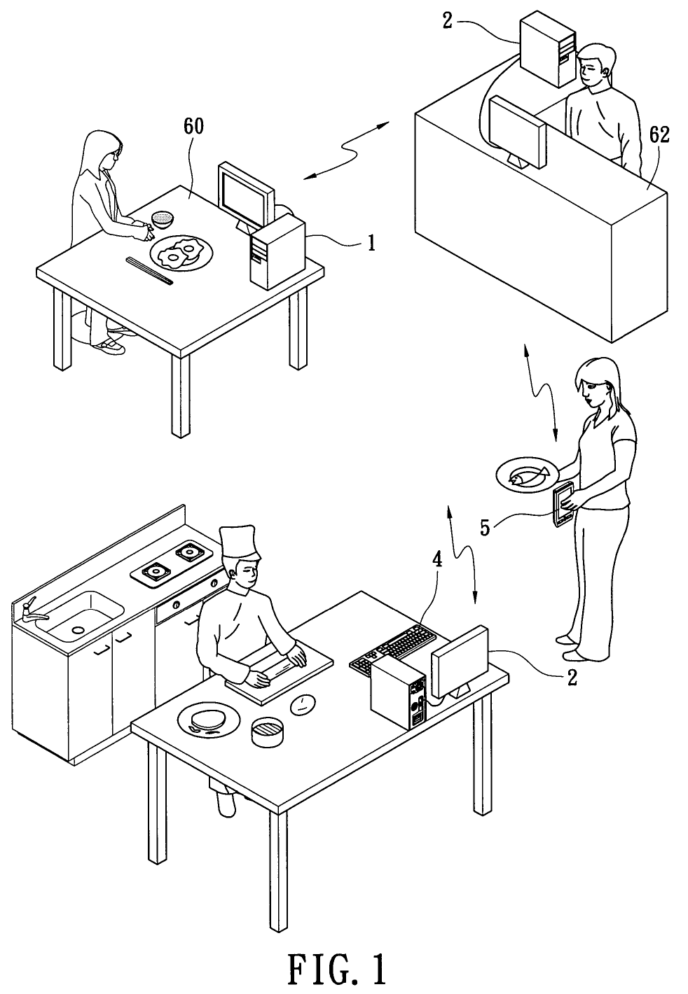

Reference is made to FIG. 1, which is a schematic diagram of an ordering system in accordance with the present invention. An ordering device 1 of the present invention is disposed on a dining table 60. The remote hosts 2 are disposed at the counter 62 and the kitchen, and the water/waitress has a portable device 5.

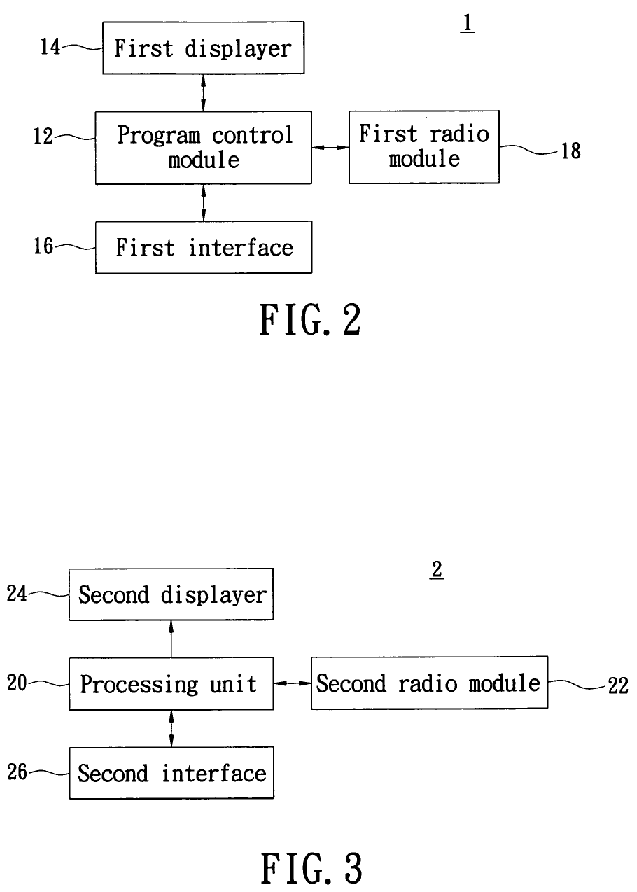

Reference is made to FIG. 2 together with FIG. 1. Therein, FIG. 2 is a circuit block of an ordering device in accordance with the present invention. The ordering device 1 of the present invention includes a program control module 12, a first displayer 14, a first interface 16 and a first radio module 18. The program control module 12 connects with the first displayer 14, first interface 16 and first radio module 18 for performing a menu process, a transaction process and a digital transmission program and controlling at least an external device connecting to the first interface 16 and the first displayer 14.

At the same time, the program control module 12 employs a first radio module 18 to communicate with the remote hosts 2 and portable device 5 in a wireless manner. The first displayer 14 of the above description is a handwriting input displayer. A customer can input a message on the handwriting input displayer via a sensing pen for signing when paying by a credit card.

The portable device 5 is a Bluetooth device or a device equipped with a wireless local area network (LAN) card. The portable device 5 can be used to perform the menu process, transaction process and digital transmission program.

The external device connecting to the first interface 16 mentioned above can be a card-reading machine, a printer, an input device, a portable storage device or a memory card. Further, the first radio module 18 is a Bluetooth module, a wireless LAN card or a radio frequency (RF) module.

Reference is made to FIG. 1 together with FIG. 3, which is a circuit block diagram of a remote host in accordance with the present invention. The remote host 2 includes: a processing unit 20, a second radio module 22, a second displayer 24 and a second interface 26. Therein, the processing unit 20 connects with the second radio module 22, second displayer 24 and second interface 26 for performing the menu process, transaction process and digital transmission program and controlling the external device connecting to the second interface 26 and the second displayer 24.

At the same time, the processing unit 20 employs the second radio module 22 to communicate with the first radio module 18 the remote ordering device 1 and the portable device 5.

The external device connecting to the second interface 26 mentioned above can be a card-reading machine, a cash-collecting machine, a input device, a printer and or network interface. Further, the second radio module 22 is a Bluetooth module, a wireless LAN card or a radio frequency (RF) module.

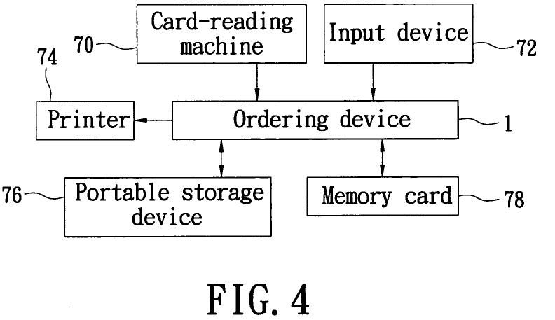

Reference is made to FIGS. 1-2 together with FIG. 4, which is a schematic diagram of the ordering device in accordance with the present invention. Therein, the ordering device 1 connects with a card-reading machine 70, a printer 74, an input device 72, a portable storage device 76 or a memory card 78.

The ordering device 1 employs the card-reading machine 70 to obtain a card identification message of user's credit card and then passes the card identification message to the remote host 2 of the counter in a wireless manner. Subsequently, the remote host 2 of the counter will connect to Internet for passing the card identification message to a remote finance company.

Further, a customer can input a handwriting signal via a sensing pen and the handwriting input displayer of the ordering device 1. Then, the program control module 12 of the ordering device 1 will perform a converting program to process the handwriting signal. Subsequently, the program control module 12 will perform a transaction process to print an invoice by the printer 74 to finish the transaction.

The ordering device mentioned above can receive a control signal from the input device 71 to perform the menu process, transaction process and digital transmission program. The input device 71 mentioned above can be a keyboard, a mouse, etc.

At the same time, the customer can connect the memory card 78 with the ordering device 1, where the memory card 78 is used to record the data of customer's authority limit for using the network. When the memory card 78 is connected with the ordering device 1, the program control module 12 will access the data of the customer's authority limit recorded in the memory card 78 and then passes it to the remote host 2 of the counter in a wireless manner. Subsequently, the remote host 2 will connect to Internet for passing the authority limit data to a remote serving center to obtain the authority to access the Internet. Further, the customer can also connect the portable storage device 76 to the ordering device 1 to store received E-mail or load data from the network.

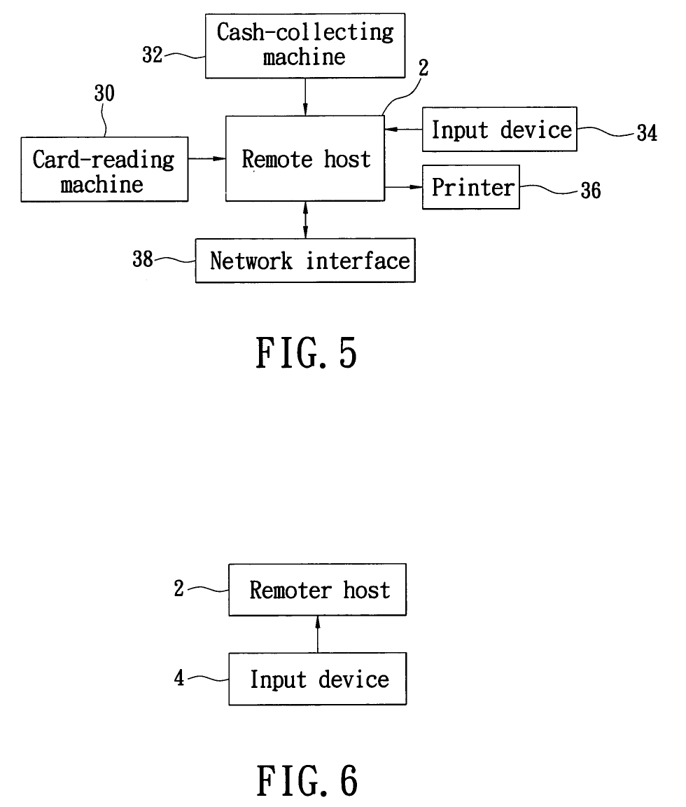

Reference is made to FIG. 5, which is a schematic diagram of a remote host disposed at a counter in accordance with the present invention. Therein, the remote host 2 of the counter is connected with a card-reading machine 30, a cash-collecting machine 32, an input device 34, a printer 36, network interface 38 and so on. The remote host 2 employs the card-reading machine 30 to obtain a card identification message from a customer's credit card and then passes the card identification message to a remote finance company for transaction. Further, the remote host 2 will receive transaction data from the cash-collecting machine 32 and print the customer's invoice via the printer 36 to finish the transaction after the transaction data is processed.

The remote host 2 as mentioned above connects with the Internet via the network interface 38 to receive or transmit digital data. At the same time, the remote host 2 is connected with the input device 34 to receive a control message, which is used to control the remote host 2 to perform a menu process, a transaction process and a digital transmission program.

Reference is made to FIG. 6, which is a schematic diagram of a remote host disposed in the kitchen in accordance with the present invention. Therein, the remote host 2 of the counter is connected with an input device 4. The remote host 2 can receive a control message from the input device 4 to perform a menu process, a transaction process and a digital transmission program correspondingly. The input device 4 can be a keyboard, a mouse, etc.

Reference is made to FIG. 1 together with FIG. 4. Summing up, a customer can use the input device 72 to transmit a control message to the ordering device 1 to browse a menu and the status thereof, make an order, surf the Internet, etc. The customer can also user the input device 72 to send a service request to the remote host 2 at the counter or the portable device 5.

After the customer finishes his meal, the ordering device 1 can be used to acquire a card identification message of user's credit card and then passes the card identification message to the remote host 2 of the counter. Subsequently, the remote host 2 of the counter is used to pass the card identification message to a remote finance company for a transaction.

At the same time, the customer can input a handwriting signal via a sensing pen and the handwriting input displayer of the ordering device 1. Then, the ordering device 1 will perform a converting program to process the handwriting signal. Subsequently, the printer 74 will be used to print an invoice to finish the transaction.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. An ordering device disposed at a dining table and connected with at least a remote host in a wireless manner, the ordering device comprising:
a program control module used for performing a menu process, a transaction process and a digital transmission program;
a first displayer connected with the program control module to show a menu, a transaction status or a digital message;
a first interface connected with the program control module for connecting at least an external device; and
a first radio module connected with the program control module for connecting the program control module with the remote host for data transfer.

2. The ordering device as claimed in the claim 1, wherein the first displayer is a handwriting input displayer.

3. The ordering device as claimed in the claim 1, wherein the external device is a card-reading machine used for receiving a card identification message and sending the card identification message to the remote host.

4. The ordering device as claimed in the claim 1, wherein the external device is a printer used for printing an invoice.

5. The ordering device as claimed in the claim 1, wherein the external device is a portable storage device used for storing downloaded digital data.

6. The ordering device as claimed in the claim 1, wherein the external device is a memory card used for recording an authority limit in network use.

7. The ordering device as claimed in the claim 1, wherein the external device is an input device.

8. The ordering device as claimed in the claim 1, wherein the first radio module is a Bluetooth module, a wireless local area network (LAN) card or a radio frequency (RF) module.

9. The ordering device as claimed in the claim 1, wherein the remote host comprises:
a processing unit used for performing the menu process, the transaction process and the digital transmission program;
a second radio module connected with the processing unit, the second radio module being used to connect with the first radio module in a wireless manner to transfer data between the processing unit and the program control module;
a second displayer connected with the processing unit for showing the menu, the transaction status or the digital message; and
a second interface connected with the processing unit for connecting with an external device.

10. The ordering device as claimed in the claim 9, wherein the external device is a network interface able to connect to Internet to receive/transmit the digital message.

11. The ordering device as claimed in the claim 9, wherein the external device is a card-reading machine used for receiving a card identification message and sending the card identification message to a remote finance company.

12. The ordering device as claimed in the claim 9, wherein the external device is a printer used for printing an invoice.

13. The ordering device as claimed in the claim 9, wherein the external device is a cash-collecting machine used to transmit transaction data to the processing unit.

14. The ordering device as claimed in the claim 9, wherein the external device is an input device.

15. The ordering device as claimed in the claim 9, wherein the second radio module is a Bluetooth module, a wireless LAN card or an RF module.

16. The ordering device as claimed in the claim 9, further comprising at least a portable device having a radio module able to connect with the second radio module in a wireless manner to transfer data to/from the processing unit, wherein the portable performs the menu process, the transaction process and the digital transmission program.

17. The ordering device as claimed in the claim 16, wherein the portable device is a Bluetooth device.

18. The ordering device as claimed in the claim 16, wherein the portable device is equipped with a wireless LAN module.

19. The ordering device as claimed in the claim 1, further comprising at least a portable device having a radio module able to connect with the first radio module in a wireless manner to transfer data to/from the program control module, wherein the portable performs the menu process, the transaction process and the digital transmission program.

20. The ordering device as claimed in the claim 19, wherein the portable device is a Bluetooth device.

21. The ordering device as claimed in the claim 19, wherein the portable device is equipped with a wireless LAN module.
